(19) United States
(12) Patent Application Publication
(10) Pub. No.: US 2009/0300923 A1
(43) Pub. Date: Dec. 10, 2009

(54) Hedge trimmer with top and side blades

(76) Inventor: Telly Durham, Hampton, GA (US)

Correspondence Address: Telly Durham, 10843 PANHANDLE RD, Hampton, GA, 30228, US

(21) Appl. No.: 12/077,315

(22) Filed: Jun. 9, 2008

(51) Int. Cl. B26B 19/02

(52) U.S. Cl. 30/216

(57) ABSTRACT

A hedge trimmer has two perpendicularly arranged cutting blades. Each of the blades has teeth and the perpendicular arrangement of the blades allows simultaneous cutting in two planes. For example, the front and top of a hedge can be simultaneously trimmed.

### TECHNICAL OF THE INVENTION

The present invention relates to the general art of gardening, and to the particular field of hedge trimmed.

### BACKGROUND OF THE INVENTION

Most commonly, hedges and shrubbery must be cut by electrically or gas-powered clippers for effective trimming. This can be expensive, especially for homeowners who must purchase such powered clippers. If one chooses to do it manually, the only tools available are pruning or scissor shears, the use of which is very time-consuming and physically exhausting.

Furthermore, many people like to provide a manicured look to their shrubbery. This can be done by neatly trimming the top surface of the shrubbery and the front surface of the shrubbery. At the present time, this operation must be carried out in two steps: trimming the top surface and then trimming the front surface. This is time consuming and difficult. It is difficult to form a sharp right angle between the top surface and the front surface of the shrubbery. For this reason, many people employ professional, which can be so expensive that many people will simply forego the look.

Thus, a need exists for an effective and inexpensive manual cutting tool which can be used by homeowners to cut, trim and prune hedges, shrubbery and even small bushes and trees to form a right angle between the front surface of the item and the top surface of the item.

### SUMMARY OF THE INVENTION

The above-discussed disadvantages of the prior art are overcome by a hedge trimmer having two perpendicularly arranged cutting blades. Each of the blades has teeth and the perpendicular arrangement of the blades allows simultaneous cutting in two planes. For example, the front and top of a hedge can be simultaneously trimmed.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a dual plane hedge trimmer embodying the present invention.

FIG. 2 shows a detail of a blade from FIG. 1.

### DETAILED DESCRIPTION OF THE INVENTION

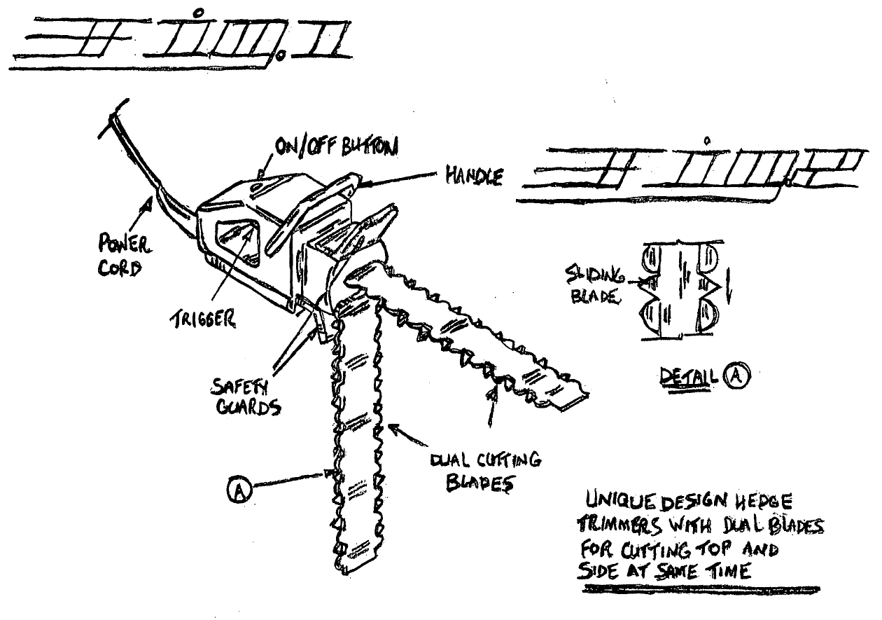

Referring to the figures, it can be understood that the present invention is embodied in a hedge trimmer 10 which permits simultaneous cutting in two planes. Trimmer 10 comprises a main housing 12 which has a motor compartment 14, a first surface 16 which is a front surface when the main housing is in use, with a use orientation being shown in FIG. 1. First surface 16 is planar. A second surface 18 is a top surface when the main housing is in use. As shown in FIG. 1, trimmer 10 has the first and second surfaces oriented perpendicular to each other.

A third 30 is a rear surface when the main housing is in use and a longitudinal axis 32 extends between the first surface and the third surface. A height axis 34 extends in the plane of the first surface. A motor 40 is located inside the motor compartment, and a power line 42 connects the motor to a power source (not shown). An on/off switch 44 is mounted on the motor housing and connects power to the motor when in the “on” condition.

A first cutting blade 50 is mounted on first surface 16 of the main housing and is operatively connected to the motor to be operated in a cutting movement when the motor is operated. First cutting blade 50 has cutting elements 52 which are movable with respect to each other to effect the cutting operation such as a hedge trimming operation. First cutting blade 50 extends outwardly from first surface 16 at a right angle to the plane of the first surface and parallel to longitudinal axis 32 of the main housing.

A second cutting blade 60 is mounted on first surface 16 of the main housing and is operatively connected to the motor to be operated in a cutting movement when the motor is operated. Second cutting blade 60 also includes cutting elements that are reciprocated with respect to each other to effect a cutting operation in the manner of cutting elements 52 discussed above. Second cutting blade 60 extends from first surface 16 to be coplanar with the first surface and at a right angle to first cutting blade 50 and at a right angle to longitudinal axis 32 of the main housing.

It is noted that the details of the mechanical linkages and systems used to simultaneously operate the two perpendicularly arranged blades do not form a part of this invention and one skilled in the art of mechanical mechanisms can understand such details based on the teaching of this disclosure. For example, the motor compartment may have one electrical motor to operate the two blades 50 and 60. Alternatively, the motor compartment may have two electric motors: a first motor for the cutting blade 50, and a second motor for the cutting blade 60. Accordingly, such details will not be claimed or disclosed.

Use of truer 10 can be understood from the foregoing description. Blades 50 and 60 are oriented at a right angle to each other so that a hedge trimming operation can be simultaneously effected in two perpendicular planes so that the front and top of a hedge can be simultaneously trimmed and will be trimmed so that the front and top of the hedge will be at a right angle with respect to each other.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A hedge trimmer comprising:
A) a main housing having
(1) a motor compartment,
(2) a first surface which is a front surface when the main housing is in use, the first surface being planar,
(3) a second surface which is a top surface when the main housing is in use,
(4) the first and second surfaces being oriented perpendicularly to each other,
(5) a third surface which is a rear surface when the main housing is in use,
(6) a longitudinal axis which extends between the first surface and the third surface,
(7) a height axis which extends in the plane of the first surface,
(8) a motor located inside the motor compartment,
(9) a power line connected to the motor, and
(10) an on/off switch mounted on the motor housing and connecting power to the motor when in the “on” condition;
B) a first cutting blade mounted on the first surface of the main housing and operatively connected to the motor to be operated in a cutting movement when the motor is operated, the first cutting blade extending outwardly from the first surface at a right angle to the plane of the first surface and parallel to the longitudinal axis of the main housing, and
C) a second cutting blade mounted on the first surface of the main housing and operatively connected to the motor to be operated in a cutting movement when the motor is operated, the second cutting blade extending from the first surface to be coplanar with the first surface and at a right angle to the first cutting blade and at a right angle to the longitudinal axis of the main housing.

2. A hedge trimmer comprising:
A) a main housing having
(1) a first surface which is a front surface when the main housing is in use, and
(2) a second surface which is a top surface when the maim housing is in use;
B) a first cutting blade mounted on the first surface of the main housing and operatively connected to a motor to be operated in a cutting movement when the motor is operated, the first cutting blade extending outwardly from the first surface at a right angle to the first surface; and
C) a second cutting blade mounted on the first surface of the main housing and operatively connected to the motor to be operated in a cutting movement when the motor is operated, the second cutting blade extending from the first surface to be coplanar with the first surface and at a right angle to the first cutting blade.
